(19) United States
(12) Patent Application Publication
(10) Pub. No.: US 2004/0153377 A1
(43) Pub. Date: Aug. 5, 2004

(54) Communication method and apparatus for use with vehicles

(76) Inventor: Ernest R. Dallman, Indianapolis, IN (US)

Correspondence Address: Intellectual Property Group, Bose McKinney & Evans LLP, 2700 First Indiana Plaza, 135 North Pennsylvania Street, Indianapolis, IN, 46204, US

(21) Appl. No.: 10/354,414

(22) Filed: Jan. 30, 2003

(51) Int. Cl. G06F 17/60

(52) U.S. Cl. 705/27

(57) ABSTRACT

According to one aspect of the present invention, a system for providing information to an occupant of a target vehicle positioned behind another vehicle in a queue of at least a first vehicle and a second vehicle is provided. The system includes a display positioned adjacent the target zone such that the display is visible to the second vehicle occupant when the second vehicle is in the target zone and a content provider coupled to the display. The content provider is configured to transmit information to the display and displaying the information on the display. The system further includes a transaction station for providing a drive-thru service to an occupant of the first vehicle. The target zone is spaced upstream of the transaction station relative to the direction of forward movement a distance corresponding to the sum of a length of a portion of the first vehicle and an approximated common spacing between the first vehicle and the second vehicle.

### FIELD OF THE INVENTION

The present invention relates to communication devices and methods for use with individuals in vehicles. More particularly, the present invention relates to devices and methods for communicating with individuals in vehicles in a queue waiting to use an Automated Teller Machine (ATM) or other transaction station.

### BACKGROUND AND SUMMARY OF THE INVENTION

Drive-thru service at ATM's, fast food restaurants, and pharmacies is used to allow individuals to perform transactions without leaving their vehicles. Queues accommodate the orderly use of drive-thru services by multiple users in vehicles. The property around drive-thrus is often laid out so as to route the vehicles into a queue, or line, so as to provide a first-come-first-served environment where later arriving vehicles wait in the queue behind the earlier arriving vehicles.

The necessary transactions and events that occur at drive-thrus are either performed at a single station (i.e., the ATM) or where there are a finite number of stations involved such as fast food and pharmacy drive-thrus. Therefore, a first individual who arrives at a station must complete all of his or her transactions associated with that station and leave the station to allow a second vehicle to approach the station. The second vehicle then carries out transactions and leaves, allowing a third individual to approach the station.

For individuals waiting in the queue, there is typically idle time spent while waiting in the queue. Thus, queues place individuals in known locations and provide them with few or no distractions or preoccupations.

According to one aspect of the present invention, a system for providing information to an occupant of a target vehicle positioned behind another vehicle in a queue of at least a first vehicle and a second vehicle is provided. The system includes a display positioned adjacent the target zone such that the display is visible to the second vehicle occupant when the second vehicle is in the target zone and a content provider coupled to the display. The content provider is configured to transmit information to the display and display the information on the display. The system further includes a transaction station for providing a drive-thru service to an occupant of the first vehicle. The target zone is spaced upstream of the transaction station relative to the direction of forward movement a distance corresponding to the sum of a length of a portion of the first vehicle and spacing between the first vehicle and the second vehicle.

According to another embodiment of the present invention a system for providing information to an occupant of a target vehicle positioned behind another vehicle in a queue of at least two vehicles is provided. The system includes a sensor configured to generate a signal in response to detecting a target vehicle in a target zone, a display positioned adjacent the target zone such that the display is visible to the target vehicle occupant when the target vehicle is in the target zone; and a content provider coupled to the sensor and the display. The content provider includes a memory to store information, and is configured to respond to receipt of the signal from the sensor by transmitting the information to the display, thereby generating information on the display for presentation to the target vehicle occupant.

According to another embodiment of the present invention, a system for providing information to an individual in a queue is provided. The system includes a first ATM encountered by the individual at a first point. The first ATM is able to host a first set of events. The system also includes a second ATM encountered by the individual at a second point. The second ATM is able to host a second set of events, the queue causes the individual to arrive at the first point before arriving at the second point.

According to yet another embodiment of the present invention, a system for providing content to an individual in a queue is provided. The system includes means for hosting a first set of events that occur at a first point, a sensor to detect the presence of an individual proximate the first point, and a station encountered by the individual at a second point. The station is able to host a second set of events. The queue causes the individual to arrive at the first point before arriving at the second point, and detection of an individual by the sensor causes automatic initiation of an event in the first set of events.

According to yet another embodiment of the present invention a system for communicating to a first individual in a queue is provided. The system includes a sensor for generating a signal upon detecting the first individual in a target zone, a first display positioned adjacent the target zone such that the display is visible to the first individual when in the target zone, a first content provider coupled to the sensor and the display. The content provider is configured to respond to receipt of the signal from the sensor by transmitting customizable information to the display for viewing by the first individual.

According to yet another embodiment of the present invention a system for providing information to an individual in a queue is disclosed. The system includes a first station encountered by the individual at a first point in the queue and an ATM encountered by the individual at a second point in the queue. The first station is able to provide information to the individual and the ATM is able to provide information to the individual.

According to another embodiment of the present invention, a method of marketing to individuals in vehicles in a queue is provided. The method includes the steps of sensing the presence of an individual in a target zone of the queue, generating a signal in response to sensing the presence of the individual within the target zone, providing a display proximate the target zone such that the display is visible to the individual, and providing a content provider coupled to the sensor and the display. The content provider is configured to respond to receipt of the signal by generating visual marketing information on the display for viewing by the individual.

According to another embodiment of the present invention, a system for providing information to an occupant of a vehicle is provided. The system includes a sensor for generating a signal upon detecting the vehicle in a target zone, a display positioned adjacent the target zone such that the display is visible to the vehicle occupant when the vehicle is in the target zone, and a content provider coupled to the sensor and the display, the content provider having information therein. The information having a starting point, the content provider being configured to respond to receipt of the signal from the sensor by transmitting the information, the starting point being transmitted first, to the display, and displaying the information on the display.

According to another embodiment of the present invention, a system for providing information to an individual in a queue includes a first station encountered by the individual at a first point in the queue, the first station able to perform informational transactions with the individual, and a second station encountered by the individual at a second point in the queue. The second station is able to perform informational and physical transactions with the individual.

According to another embodiment of the present invention, a satellite ATM is provided including a display and a content provider coupled to the display. The content provider enables the satellite ATM to only perform informational transactions.

According to another embodiment of the present invention, a system for providing information to an occupant of a target vehicle positioned behind another vehicle in a queue of at least a first vehicle and a second vehicle is provided. The system includes a sensor for generating a signal upon detecting entry of the second vehicle into a target zone, a display positioned adjacent the target zone such that the display is visible to the second vehicle occupant when the second vehicle is in the target zone, and a content provider coupled to the sensor and the display. The content provider is configured to respond to receipt of the signal from the sensor by transmitting information to the display and displaying the information on the display.

Additional features of the invention will become apparent to those skilled in the art upon consideration of the following detailed description of the preferred embodiment exemplifying the best mode of carrying out the invention as presently perceived.

### BRIEF DESCRIPTION OF THE DRAWINGS

The detailed description particularly refers to the accompanying figures in which:

FIG. 1 is an overhead view of a first embodiment communication station in use in the field;

FIGS. 2a-c are front elevational, back elevational, and top cross-sectional views respectively, of the first embodiment communication station;

FIGS. 3a-c are front elevational, side elevational, and top cross-sectional views respectively, of a second embodiment communication station similar to the station of FIG. 2;

FIGS. 4a-c are front elevational, side elevational, and top cross-sectional views respectively, of a third embodiment communication station similar to the stations of FIGS. 2 and 3;

FIGS. 5a-c are front elevational, side elevational, and top cross-sectional views respectively, of a fourth embodiment communication station similar to the stations of FIGS. 2-4;

FIGS. 6a-c are front elevational, side elevational, and top cross-sectional views respectively, of a fifth embodiment communication station similar to the stations of FIGS. 2-5;

FIG. 7a-c are front elevational, side elevational, and top cross-sectional views respectively, of a sixth embodiment communication station similar to the stations of FIGS. 2-6;

FIG. 8 is an overhead view of a seventh embodiment combination ATM and communication kiosk in use in the field; and

FIGS. 9a-d are a plurality of views of the seventh embodiment combination ATM and communication kiosk.

### DETAILED DESCRIPTION OF THE EMBODIMENTS OF THE INVENTION

While the invention is susceptible to various modifications and alternative forms, exemplary embodiments thereof have been shown by way of example in the drawings and will herein be described in detail. It should be understood, however, that there is no intent to limit the invention to the particular forms disclosed, but on the contrary, the intention is to cover all modifications, equivalents, and alternatives falling within the spirit and scope of the invention as defined by the appended claims.

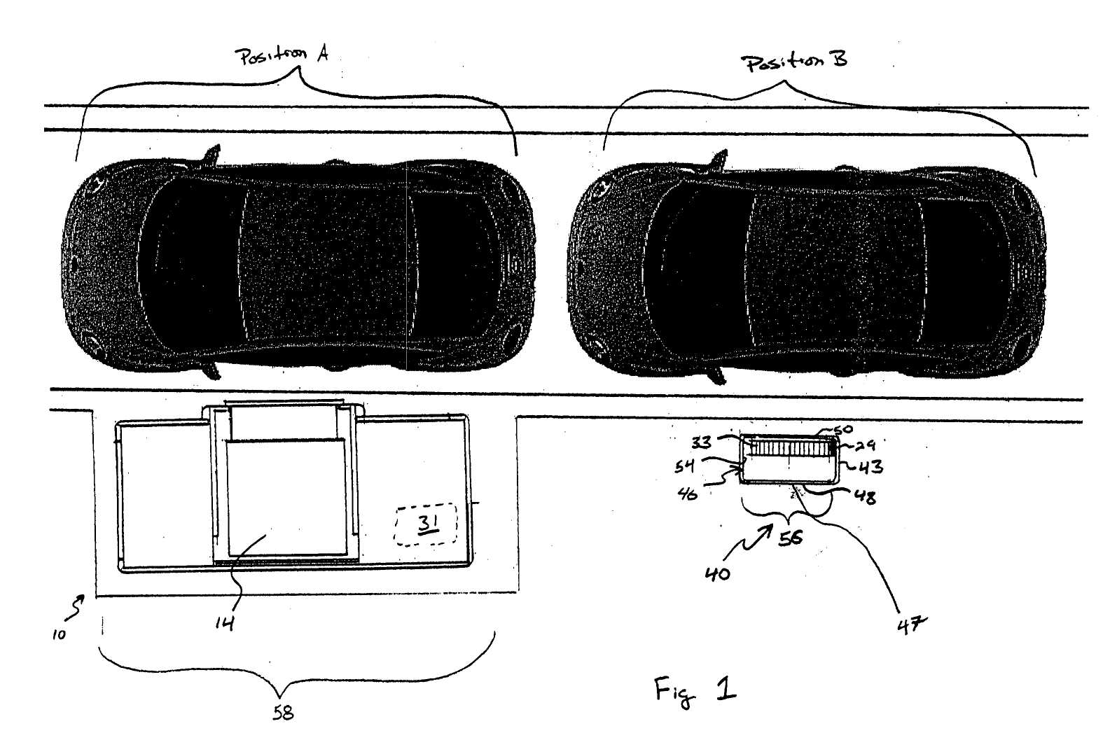

As shown in FIG. 1, drive-thru transaction stations and drive-thru ATMs 14 are placed in the field in positions that allow vehicles to drive up next to the station or ATM such that a driver's side window of the vehicle is positioned near the drive-thru station or ATM 14 (position A). Certain embodiments not shown herein also allow for a passenger's side window to be next to the drive-thru station or ATM 14. It should be appreciated that while the majority of this specification describes use of a queue for a drive-thru ATM 14, the communication devices and methods described herein can also be used with drive-thru stations at fast food restaurants, pharmacies, or any other situations involving individuals in queues or other known locations.

ATMs 14 can either be housed in stand-alone kiosks 10 as shown in FIGS. 1, 8, and 9 or can be integrated into larger buildings. By utilizing the drive-thru or ATM 14, individuals can then conduct transactions without leaving their vehicle. ATM 14 transactions typically include the individual providing media, such as an ATM card, with indicia of a user account which, when combined with an authentication code, allows the individual access to his/her account. Other methods of providing access are envisioned such as through fingerprinting, retinal scanning, the use of low power wireless transmitters, or any other method to allow an individual to securely access his/her account.

As shown in FIG. 1, an auxiliary interface panel 40 is located at a first station 56 and a physical transaction station such as conventional ATM 14 is located at a second station 58. Physical transaction stations are stations where something physical is either taken from or left at the station, such as money, food, drugs or the like.

As described above, drive-thru ATMs 14 usually utilize a queue. By knowing the characteristics of the queue, whether engineered or naturally occurring, the position of vehicles waiting in the queue can be approximated. Thus a target zone, position B, can be predicted. Free standing auxiliary interface panel 40 is placed proximate the target zone to either passively provide information (e.g., traditional advertising) to the waiting individuals and/or to function as a satellite ATM or interactive station 47 as further described below.

Auxiliary interface panel 40 may passively provide advertising that runs constantly. In such a case, content provider 31 provides advertising in a loop to keep advertising running at all times. As vehicles arrive in position B (FIG. 1), the individuals in the vehicles are exposed to the running advertisements. Position B is defined as the position where the panel 40 may communicate to an individual in a vehicle.

Alternatively, auxiliary interface panel 40 includes a sensor 29 to detect when a vehicle is in position B. Sensor 29 is able to detect the vehicle in position B by virtue of the position of sensor 29 and by logic programming or chips that correlate sensing by sensor 29 and the time when the vehicle will be in position B. Sensor 29 generates a signal which is received by a content provider 31. Upon receiving the signal from sensor 29 the programming or logic chips interpret the signal along with information about the location of sensor 29 and panel 40 to cause content provider 31 to transmit signals to panel 40 as the vehicle arrives at position B. The signals are audio/visual signals including information representing a presentation or advertisement to monitor 33 and (optionally) the speaker. Sensor 29 also detects when the vehicle leaves position B by sensing the absence of a vehicle in position B. When sensor 29 indicates that no vehicle is in position B, content provider 31 stops providing content signals. Content provider 31 then waits for sensor 29 to detect another vehicle in the target zone (position B). When content provider 31 receives another signal indicating the presence of a vehicle in the target zone, content provider 31 may rewind the presentation or otherwise take steps to prepare the presentation for playback from the beginning. Content provider 31 then transmits content signals to monitor 33 and the speaker so that the presentation is experienced by the occupant(s) of the vehicle in position B. Alternatively, the preparation to restart the presentation may begin immediately upon receipt of the signal from sensor 29 indicating the absence of a vehicle within the target zone. It should be understood that in other embodiments of kiosk 10 and auxiliary interface panel 40, the presentation may be paused during the absence of vehicles in position B instead of being restarted from the beginning. Further, embodiments are envisioned where the advertising runs in a continuous loop thereby making the sensor unnecessary for starting and stopping the content provider.

Auxiliary interface panel 40 is located at a first station 56 and may be a station for one way communication from the content provider 31 to the individual such as advertising or an interactive station 47 that can perform many of the tasks and transactions of a conventional ATM located at a second station 58, but not dispense money or receive deposits (a satellite ATM). Interactive station 47 according to the present invention does not dispense money or receive deposits because interior volume 54 of housing 46 is smaller than that of conventional ATMs, thus providing a problem for storing cash to distribute and deposits to receive. Also, interactive station 47, by not distributing money or receiving deposits, does not need to be constructed so as to prevent thieves from gaining entry thereto.

Interactive station 47 may receive account-indicating media and may receive input from the individual, preferably via a touchscreen or a keypad. To use interactive station 47, an individual arrives at position B and submits his/her user account media to interactive station 47. He/she then proceeds to input information detailing the transactions he/she wishes to make. Transactions that are completely electronic, such as balance inquiries and transfers between accounts can be completed at interactive station 47. If a withdrawal or a deposit transaction is to be made, the size of the transaction is specified at interactive station 47 and the user account media is returned to the individual. Once conventional ATM 14, the physical transaction station, is available, (position A is vacant), the individual can proceed to conventional ATM 14, provide the user account media, and then deposit or retrieve the funds specified at interactive station 47. Therefore, the individual only spends enough time in position A as necessary to authenticate himself/herself and to then receive monies requested or make deposits previously indicated at interactive station 47. Some transactions performed at interactive station 47, such as inputting how much money is to be withdrawn and from which account, do not need to be repeated at conventional ATM 14 because interactive station 47 transmits the input amount information to conventional ATM 14. The manner of communication between interactive station 47 and conventional ATM 14 may be implemented using hardwired electrical connections, wireless connections, or any other conventional technique. Thus, the time spent at conventional ATM 14 is shortened and vehicles proceed through the queue faster.

Embodiments are envisioned wherein some individuals in the queue are instructed to perform transactions only at conventional ATM 14, not interactive station 47, such that both stations receive maximum use efficiency and allow the line in the queue to move as quickly as possible. In such embodiments, when there is a line in the queue, vehicles may arrive at position B adjacent interactive station 47 to find a message on a monitor 33 telling the occupants that conventional ATM 14 will be available very soon. Passive information (e.g., advertisements) will then be displayed to the individual as he/she waits for the conventional ATM 14 to become available. Such an embodiment may be employed, for example when there are four individuals in vehicles in a queue. The first individual is located at position A and begins his/her transactions with conventional ATM 14. The second individual is located in position B and begins his/her transaction. At this point, both the first individual and the second individual are performing transactions at their respective positions. The second individual is able to perform all transactions involving the exchange of information only (“informational transactions”). While at interactive station 47, the second individual cannot perform transactions requiring the deposit or receipt of money (“physical transactions”). Therefore, once the second individual has completed all informational transactions he/she is ready to proceed to position A. Once the first individual has completed his/her transactions and left position A, the second individual can move forward to position A and either stop to perform a physical transaction, or leave if he/she does not need to perform a physical transaction. The time it takes to perform the physical transactions is typically shorter the time required to perform the informational transactions.

Once the second individual proceeds to position A, the third individual may move forward to position B. Assume, for example, the second individual stops at position A to perform a physical transaction after performing informational transactions at position B. Based on the second individual's informational transactions, interactive station 47 may deduce that the second individual will perform only physical transactions at conventional ATM 14. Accordingly, interactive station 47 instructs the third individual to wait for the second individual to finish at conventional ATM 14 and to then proceed to conventional ATM 14. While the second individual performs physical transactions at conventional ATM 14, advertisements may play at interactive station 47 to the third individual. Once the second individual is finished and leaves position A, the third individual may proceed to position A to use conventional ATM 14. Also, the fourth individual may proceed to position B to use interactive station 47.

However, it should be appreciated that when the third individual enters position B, if the transactions of the second individual while at interactive station 47 have indicated that the second individual will likely be spending more than a pre-defined amount of time at conventional ATM 14, interactive station 47 can allow the third individual to use interactive station 47 rather than instructing the third individual to wait for conventional ATM 14.

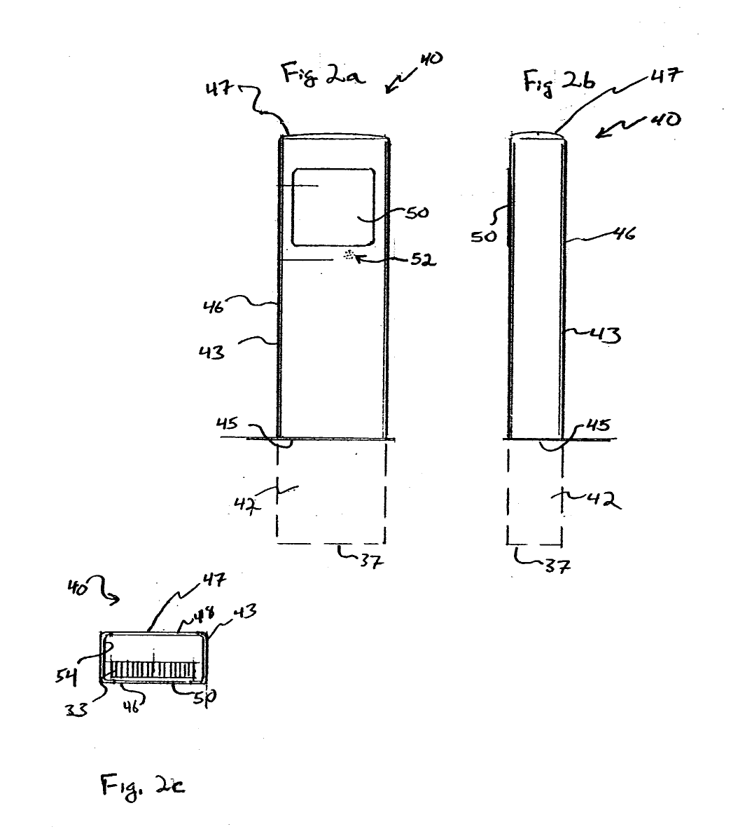

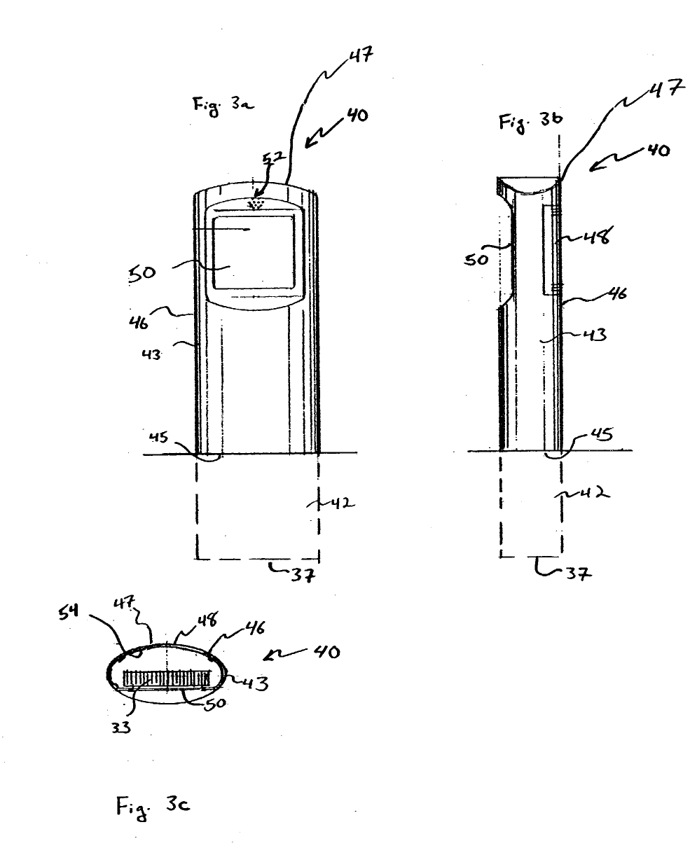

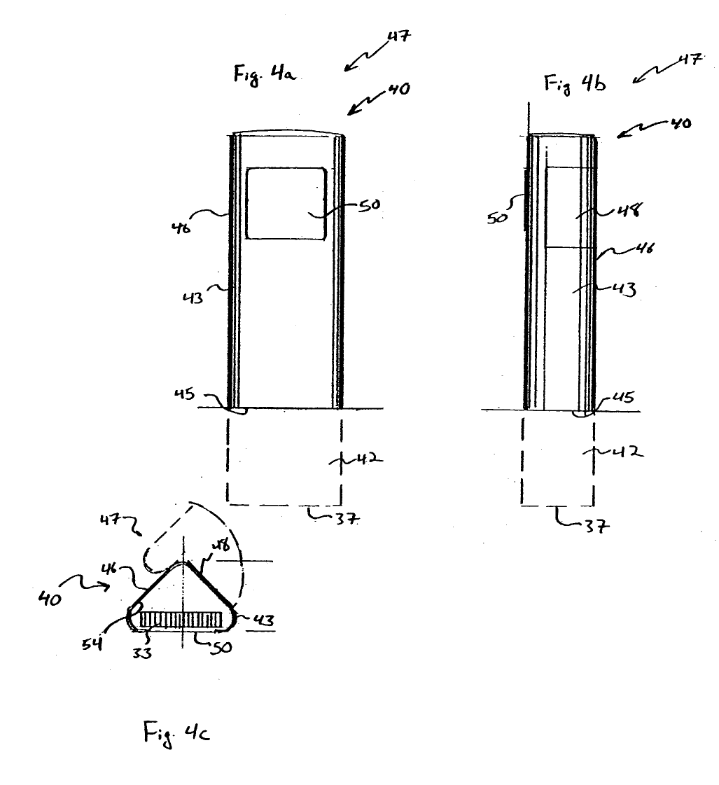

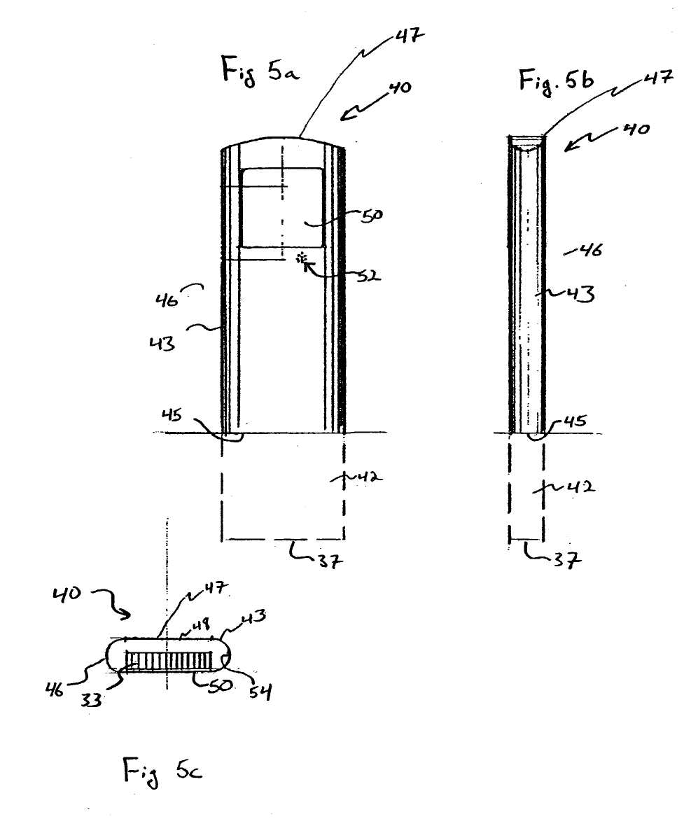

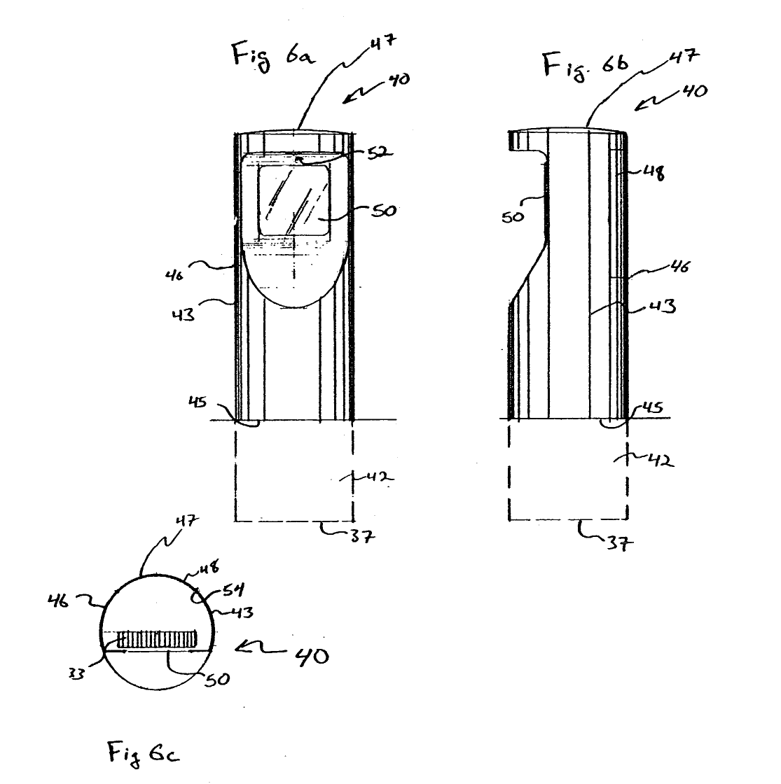

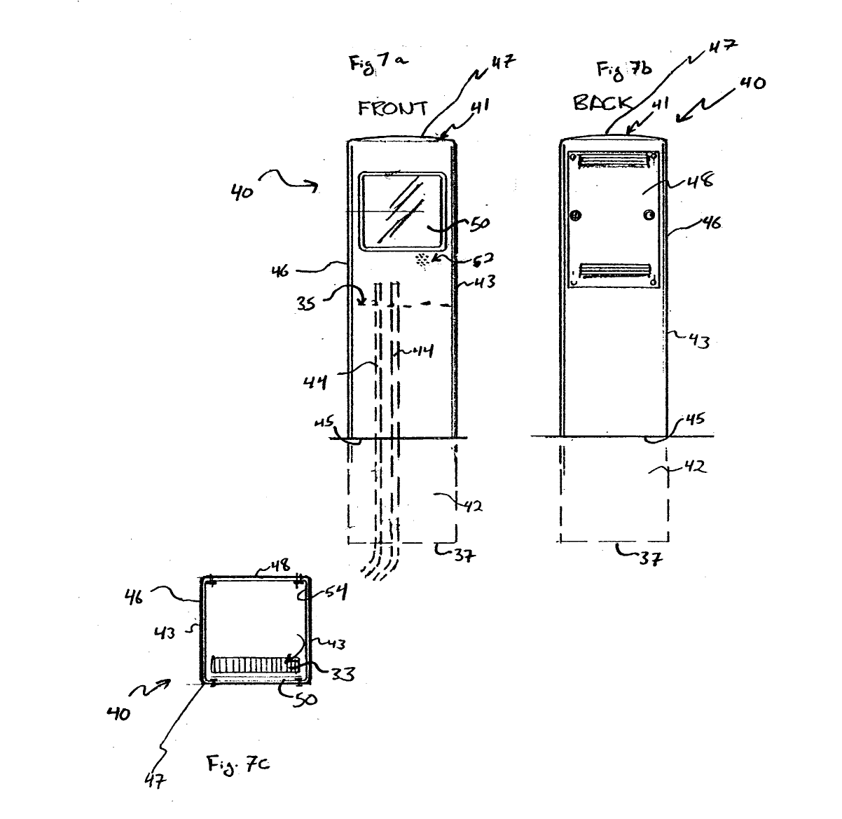

FIGS. 2-7 show alternative embodiment free standing auxiliary interface panels 40 that may be utilized in the queue of FIG. 1. In one embodiment, interface panel 40 may include a concrete base 42, one or more conduit 44 extending through concrete base 42, a housing 46, a display or monitor 33, a speaker (not pictured), and a ventilation unit (not pictured). Concrete base 42 is 4′6″ high and is sized and shaped to extend 2′ below the ground. Both conduit 44 extend from of a top 35 to a bottom 37 of concrete base 42 and provide pathways for electrical cabling to pass therethrough to connect monitor 33 and the speaker to power and to content provider 31. While content provider 31 is preferably located remotely from panel 40, embodiments are also envisioned where content provider 31 is located within an interior volume 54 of housing 46. Housing 46 includes a back panel 48, a LEXAN window 50, and a plurality of apertures 52 similar to apertures 36. Back panel 48 allows ventilation of auxiliary interface panel 40 and may be removed to access monitor 33 and the speaker. Housing 46 also includes a top 41, a side or plurality of sides 43, and a base 45 to define interior volume 54 therein. Housing 46 is sized and shaped to fit over concrete base 42 such that concrete base 42 occupies a significant portion of interior volume 54 of housing 46. Monitor 33 is placed behind LEXAN window 50 so as to be visible through window 50. The speaker is placed behind apertures 52. As is further described below, in one embodiment monitor 33 includes a touchscreen type display to receive input from an occupant of a vehicle in position B. Alternatively, other input devices may be located proximate monitor 33. Such other input devices may include a microphone, a touchpad, a keyboard, a camera, an infrared receiver, a radio frequency receiver, a card reader, or the like. Through input from the vehicle occupant, the content provided to the user may be customized for greater efficacy. Such customization may include choosing one message or advertisement to display from a set of messages or advertisements based on the inputted information. Such information may include age, past purchases, income level, account balance, services provided, sex, length of time since last interaction, name, and account number.

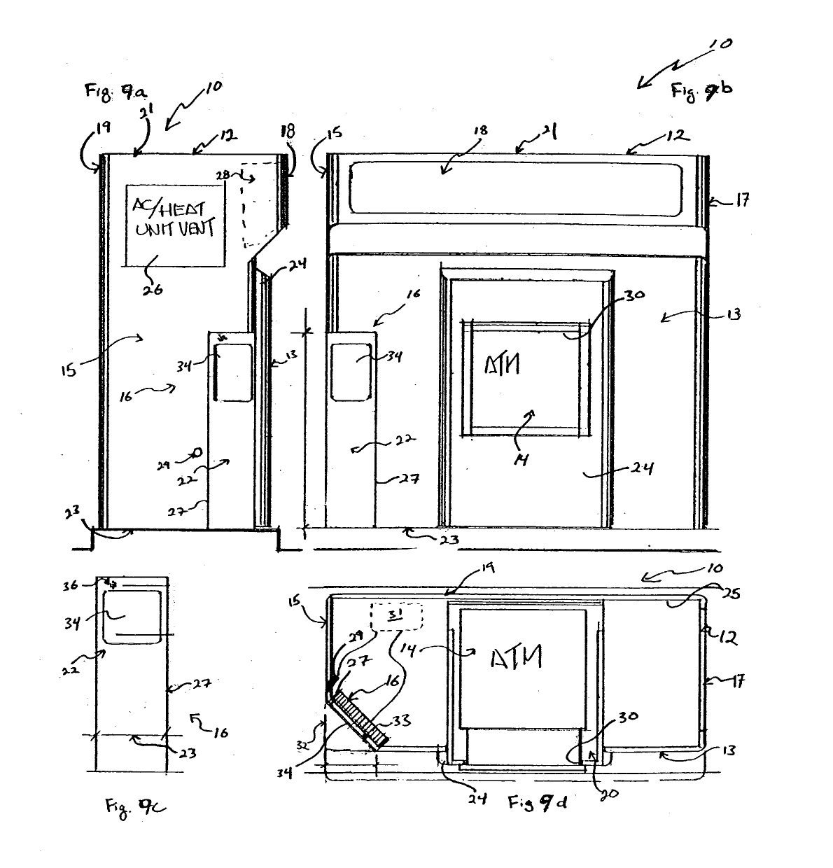

FIG. 9b illustrates a front view of an alternative embodiment ATM kiosk 10 of the present invention. Kiosk 10 includes a housing 12, an ATM 14, and an auxiliary interface 16. Housing 12 includes an overhead marquee 18, a platen 20 to receive ATM 14 therein, an auxiliary interface panel 22, a fascia 24, an interior volume 25, and a vent 26 to allow interior volume 25 of housing 12 to be in fluid communication with the ambient air. Housing 12 includes a front 13, a left side 15, a right side 17, a back 19, a top 21, and a base 23 that combine to define interior volume 25.

Platen 20 has ATM 14 located thereon or therein depending on construction. Platen 20 is preferably a linear motion platen 20 that allows ATM 14 to be extended outside of housing 12 for replenishment and servicing. However, a sealed bearing turnstyle platen may also be used. A sealed bearing turnstyle platen rotates ATM 14 inside housing 12 for the purposes of replenishment and servicing.

In one embodiment, auxiliary interface panel 22, shown in FIG. 9c, is mounted at a 45-degree angle relative to each of front 13 and left side 15 on a corner wall 27 of housing 12. Corner wall 27 extends from base 23 upwards, a portion of the height of housing 12. The balance of the height of kiosk 10 extends outwardly as shown by the phantom line 32 of FIG. 9d and provides overhead protection for auxiliary interface panel 22. Auxiliary interface panel 22 includes a window 34 made of LEXAN or the like and may be a lens. Panel 22 also has a plurality of small apertures 36 to permit the transmission of sound therethrough. Window 34 is sized and shaped to allow 15″ display or monitor 33 to be placed within interior volume 25 of housing 12 and show through window 34. Of course, window 34 could be sized and shaped to allow other sized monitors 33 to show therethrough. Additionally, one or more speakers (not pictured) are placed within interior volume 25 behind small apertures 36. Vent 26 is located in left side 15 of housing 12. While the word “display” is commonly used herein to refer to monitor 33, it should be appreciated that a speaker is also a “display” for audio information.

ATM 14 is a conventional ATM device commonly known in the art for interacting with customers to perform typical banking tasks. ATM 14 has a fascia 24 that aesthetically integrates ATM 14 with larger surrounding kiosk 10. Fascia 24 may be coupled to platen 20 to move therewith and, when platen 20 is in interior volume 25, extend from front 13 of housing 12 to increase the depth of housing 12 by about 6″. Fascia 24 includes an aperture 30 that allows a customer to access ATM 14.

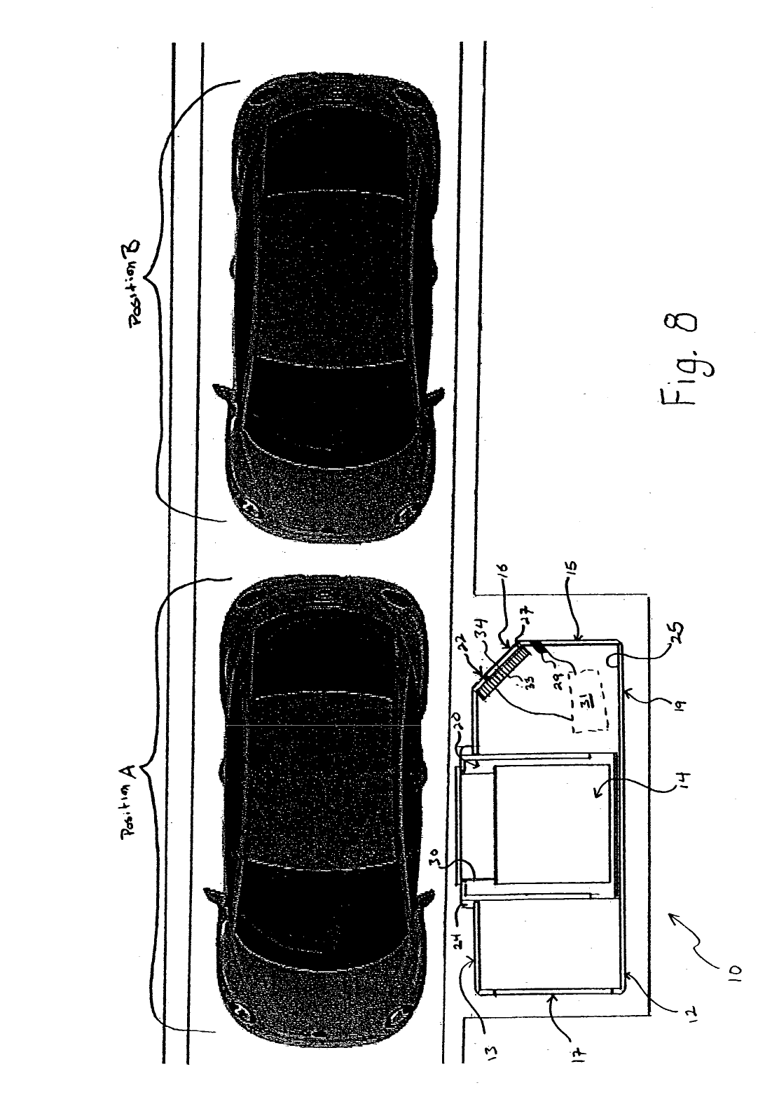

In use, kiosk 10 is placed in the field in a position that allows vehicles to drive up next to kiosk 10 such that a driver's side window of the vehicles is positioned near ATM 14 (position A) as shown in FIG. 8. Individuals can then conduct transactions without leaving their vehicle. Such transactions typically include the individual providing media, such as an ATM card, with indicia of a user account which, when combined with an authentication code, allows the individual access to his/her account. Other methods of providing access are envisioned such as through fingerprinting, retinal scanning, the use of low power wireless transmitters, or any other method to allow an individual to securely access his/her account.

The area surrounding kiosk 10 in drive-thru applications also usually includes a queue, or a path of some type in which a line of vehicles will form in the event that multiple users simultaneously desire to use ATM 14. The surroundings of kiosk 10 can be designed to generate a particular desired path for the queue. Alternatively, a queue may naturally form without such manipulation of the surroundings. By knowing the characteristics of the queue, whether engineered or naturally occurring, the position of vehicles in the queue can be approximated. Factors considered when approximating the position of vehicles in the queue are vehicle lengths and typical spacing between vehicles. As an example, the position of an upstream vehicle may be approximated by adding a length of a portion of the downstream vehicle and an approximated common spacing between the downstream vehicle and the upstream vehicle. Since these factors vary, the vehicle position that can be most accurately predicted, except for the vehicle conducting the transaction at ATM 14, (position A), is the position of the vehicle immediately behind (upstream of) the vehicle in position A, shown in FIG. 8 as position B.

As previously stated, auxiliary interface panel 22, shown in FIGS. 9a-d, is mounted on corner wall 27 at a 45-degree angle relative to each of front 13 and left side 15 of housing 12 of kiosk 10. The 45-degree orientation of panel 22 allows monitor 33 positioned behind window 34 to be viewable by an individual in a vehicle located at position B. Monitor 33 is preferably viewable by the individual through the front windshield of the individual's vehicle when the vehicle is properly located.

Kiosk 10 further includes a sensor 29 to detect when a vehicle is in position B. Sensor 29 may be a photodetector, a laser, an infrared (IR) beam, a heat sensor, a vibration sensor, a magnetic sensor, a fiber-optic pressure mat, a weight sensor, or any other type of sensor that can detect when a vehicle is in a target zone such as position B. Once a vehicle is detected in position B, sensor 29 generates a signal which is received by a content provider 31 that may be located within interior volume 25 of housing 12. Alternatively, the content provider may be located remotely from housing 12 such as in a nearby bank or a separate nearby housing. Content provider 31 is coupled to monitor 33 and (optionally) the speaker. Content provider 31 may include a computer, a VCR, a DVD player, a VCD player, or any other device capable of transmitting information for display on monitor 33. ATM 14 may also have its own internal content provider (not pictured). Content provider 31 may include a processor and a computer readable medium for storing digital data or other memory device (not pictured) for storing the digital data. The digital data represents visual information and the processor is able to access the digital data and convert the data into visual information on the display. The memory device may be integral (hardwired) or removable from content provider 31. Upon receiving the signal from sensor 29, content provider 31 transmits content signals such as audio/visual signals including information representing a presentation or advertisement to monitor 33 and the speaker. Sensor 29 also detects when the vehicle leaves position B by sensing the absence of a vehicle in position B. When sensor 29 indicates that no vehicle is in position B, content provider 31 stops providing content signals to monitor 33 and the speaker. Content provider 31 then waits for sensor 29 to detect another vehicle in the target zone (position B). When content provider 31 receives another signal from sensor 29 indicating the presence of a vehicle in the target zone, content provider 31 may rewind the presentation or otherwise take steps to prepare the presentation for playback from the beginning of the presentation. Content provider 31 then transmits content signals to monitor 33 and the speaker so that the presentation is experienced by the occupant(s) of the vehicle in position B. Alternatively, content provider 31 may prepare to restart the presentation from the beginning immediately upon receipt of the signal from sensor 29 indicating the absence of a vehicle within the target zone.

It should be appreciated that while embodiments with two stations have been disclosed, embodiments with more than two stations are envisioned. Also, the ATM embodiments described above can be applied to queues of other types, such as fast food queues and pharmacy queues. While the preceding examples disclose queues of cars, the present invention could also be applied to individuals waiting in queues outside of vehicles. Furthermore, although the invention has been described in detail with reference to certain illustrated embodiments, variations and modifications exist within the scope and spirit of the present invention as described and defined in the following claims.

What is claimed is:

1. A system for providing information to an occupant of a target vehicle positioned behind another vehicle in a queue of at least a first vehicle and a second vehicle, the system including:
a display positioned adjacent a target zone such that the display is visible to the second vehicle occupant when the second vehicle is in the target zone;
a content provider coupled to the display, the content provider being configured to transmit information to the display and displaying the information on the display; and
a transaction station for providing a drive-thru service to an occupant of the first vehicle, the target zone being spaced upstream of the transaction station relative to the direction of forward movement a distance corresponding to the sum of a length of a portion of the first vehicle and spacing between the first vehicle and the second vehicle.

2. The system of claim 1 further including a sensor for generating a signal upon detecting entry of the second vehicle into a target zone.

3. The system of claim 2 wherein the transaction station includes the display.

4. The system of claim 2 wherein the sensor includes a light sensing element that detects light interference caused by the second vehicle.

5. The system of claim 2 wherein the sensor includes a weight sensing element that detects a weight of the second vehicle.

6. The system of claim 2 wherein the sensor includes a heat sensing element that detects heat emitted by the second vehicle.

7. The system of claim 2 wherein the sensor includes a vibration sensing element that detects vibration caused by the second vehicle.

8. The system of claim 2 wherein the sensor includes a magnetic field sensing element that detect a change in a magnetic field caused by the second vehicle.

9. The system of claim 2 wherein the sensor is further configured to generate a second signal in response to detecting the second vehicle exiting the target zone.

10. The system of claim 9 wherein the content provider is further configured to respond to receipt of the second signal from the sensor by discontinuing the displaying of information on the display.

11. The system of claim 1 wherein the display is positioned for viewing through a front, driver's side window of the second vehicle when the second vehicle is stopped in the target zone.

12. The system of claim 1 wherein the display is positioned for viewing through a front windshield of the second vehicle when the second vehicle is stopped in the target zone.

13. The system of claim 1 wherein the content provider includes a video playback device and a storage medium for storing data representing visual information, the video playback device retrieving the data and converting the retrieved data into the visual information on the display.

14. The system of claim 1 wherein the content provider includes a processor and a computer readable medium for storing digital data representing visual information, the processor accessing the digital data and converting the accessed data into the visual information on the display.

15. The system of claim 1, wherein the display is a speaker and the information is audio information.

16. A system for providing information to an occupant of a target vehicle positioned behind another vehicle in a queue of at least two vehicles, the system including:
a sensor configured to generate a signal in response to detecting a target vehicle in a target zone;
a display positioned adjacent the target zone such that the display is visible to the target vehicle occupant when the target vehicle is in the target zone; and
a content provider coupled to the sensor and the display, the content provider including a memory to store information, the content provider being configured to respond to receipt of the signal from the sensor by transmitting the information to the display, thereby generating information on the display for presentation to the target vehicle occupant.

17. The system of claim 16 further including a speaker positioned adjacent the target zone, the content provider being configured to respond to receipt of the signal from the sensor by generating audible information for listening by the target vehicle occupant.

18. A system for providing information to an individual in a queue including:
a first ATM encountered by the individual at a first point, the first ATM able to host a first set of events; and
a second ATM encountered by the individual at a second point, the second ATM able to host a second set of events, the queue causing the individual to arrive at the first point before arriving at the second point.

19. The system of claim 18, wherein the first set of events is a subset of the second set of events.

20. The system of claim 18, wherein the second ATM is a conventional ATM and the first ATM is a satellite ATM.

21. The system of claim 18, wherein the first set of events includes: receiving indicia of a user account, receiving user authentication input, receiving indicia of a user's desire to make a deposit, receiving indicia of a user's desire to make a withdrawal, receiving indicia of the user's desire to check an account balance, providing the user an account balance, receiving indicia of the user's desire to transfer funds between accounts, displaying advertising to an individual, and transferring funds between accounts.

22. The system of claim 21, wherein the second set of events includes: all of the events in the first set of events, receiving deposits, and dispensing withdrawals.

23. The system of claim 21, wherein the event of receiving indicia of a user account is performed by receiving media with account information therein.

24. The system of claim 18, wherein at least one of the events hosted at the first ATM for the user is not repeated at the second ATM.

25. The system of claim 24, wherein the at least one event is not repeated at the second ATM because hosting of the at least one event at the first ATM renders unnecessary the hosting of the at least one event at the second ATM.

26. The system of claim 24, wherein information received during the at least one event is transferred to the second ATM.

27. A system for providing content to an individual in a queue including:
means for hosting a first set of events that occur at a first point;
a sensor to detect the presence of an individual proximate the first point; and
a station encountered by the individual at a second point, the station able to host a second set of events, the queue causing the individual to arrive at the first point before arriving at the second point, and detection of an individual by the sensor causing automatic initiation of an event in the first set of events.

28. The system of claim 27, wherein the first set of events is a subset of the second set of events.

29. The system of claim 27, wherein the hosting means includes a satellite ATM.

30. The system of claim 27, wherein the hosting means includes the station located at the second point that is able to host the event at the first point.

31. The system of claim 30, wherein the hosting means includes an advertising kiosk.

32. The system of claim 31, wherein the sensor initiates a first event directed towards the individual in response to detection of an individual within the target zone.

33. The system of claim 32, wherein the first event is exposing the individual to an advertisement.

34. The system of claim 29, wherein the event conducted at the first point is determined by receiving information about the individual and tailoring the event based on the received information.

35. The system of claim 34, wherein the information is received from a wireless transmitter.

36. The system of claim 35, wherein the information is received from media possessed by the individual.

37. The system of claim 36, wherein the media possessed by the individual include user-specific information relating to one of: age, past purchases, income level, account balance, services provided, sex, length of time since last interaction, name, and account number.

38. A system for communicating to a first individual in a queue, the system including:
a sensor for generating a signal upon detecting the first individual in a target zone;
a first display positioned adjacent the target zone such that the display is visible to the first individual when in the target zone; and
a first content provider coupled to the sensor and the display, the content provider being configured to respond to receipt of the signal from the sensor by transmitting customizable information to the display for viewing by the first individual.

39. The system of claim 38, the system further including a second display and a second content provider coupled to the second display for use by a second individual.

40. The system of claim 39, wherein the second individual is ahead of the first individual in the queue.

41. The system of claim 39, wherein after leaving the target zone, the first individual proceeds to the second display and use of the first display reduces the time spent by the first individual at the second display.

42. A system for providing information to an individual in a queue including:
a first station encountered by the individual at a first point in the queue, the first station able to provide information to the individual; and
an ATM encountered by the individual at a second point in the queue, the ATM able to provide information to the individual.

43. The system of claim 42, wherein each of the first station and the ATM include a display for providing visual information to the individual.

44. The system of claim 43, wherein each of the displays are coupled to a content provider.

45. The system of claim 42, wherein the first station is a satellite ATM.

46. The system of claim 42, wherein the first station is an advertising station.

47. A method of marketing to individuals in vehicles in a queue including the steps of:
sensing the presence of an individual in a target zone of the queue;
generating a signal in response to sensing the presence of the individual within the target zone;
providing a display proximate the target zone such that the display is visible to the individual; and
providing a content provider coupled to the sensor and the display, the content provider being configured to respond to receipt of the signal by generating visual marketing information on the display for viewing by the individual.

48. The method of claim 47, wherein the content provider and the display are provided as part of an ATM.

49. The method of claim 47, wherein the method is performed as the individual is waiting to perform another task.

50. The method of claim 47, wherein the target zone is separate from a second zone that is a destination of the queue.

51. The method of claim 47, further comprising the steps of:
detecting when the individual leaves the target zone;
ending the generating of visual information on the display in response to the detecting step; and
waiting for the sensing of a second individual in the target zone.

52. The method of claim 51, wherein the waiting step includes the step of preparing the visual information to restart at a beginning point for the second individual.

53. A system for providing information to an occupant of a vehicle, the system including:
a sensor for generating a signal upon detecting entry of the vehicle into a target zone;
a display positioned adjacent the target zone such that the display is visible to the vehicle occupant when the vehicle is in the target zone; and
a content provider coupled to the sensor and the display, the content provider having information therein, the information having a starting point, the content provider being configured to respond to receipt of the signal from the sensor by transmitting the information, the starting point being transmitted first, to the display, and displaying the information on the display.

54. The system of claim 53 wherein the sensor is further configured to generate a second signal in response to detecting the second vehicle exiting the target zone.

55. The system of claim 54 wherein the content provider is further configured to respond to receipt of the second signal from the sensor by discontinuing the displaying of information on the display.

56. A system for providing information to an individual in a queue including:
a first station encountered by the individual at a first point in the queue, the first station able to perform informational transactions with the individual; and
a second station encountered by the individual at a second point in the queue, the second station able to perform informational and physical transactions with the individual.

57. The system of claim 56, wherein informational transactions include: receiving indicia of a user account, receiving user authentication input, receiving indicia of a user's desire to make a deposit, receiving indicia of a user's desire to make a withdrawal, receiving indicia of the user's desire to check an account balance, providing the user an account balance, receiving indicia of the user's desire to transfer funds between accounts, displaying advertising to an individual, and transferring funds between accounts.

58. The system of claim 56, wherein physical transactions include receiving deposits and dispensing withdrawals.

59. A satellite ATM including:
a display; and
a content provider coupled to the display, the content provider enabling the satellite ATM to perform only informational transactions.

60. The system of claim 59, wherein informational transactions include: receiving indicia of a user account, receiving user authentication input, receiving indicia of a user's desire to make a deposit, receiving indicia of a user's desire to make a withdrawal, receiving indicia of the user's desire to check an account balance, providing the user an account balance, receiving indicia of the user's desire to transfer funds between accounts, displaying advertising to an individual, and transferring funds between accounts.

61. A system for providing information to an occupant of a target vehicle positioned behind another vehicle in a queue of at least a first vehicle and a second vehicle, the system including:
a sensor for generating a signal upon detecting entry of the second vehicle into a target zone;
a display positioned adjacent the target zone such that the display is visible to the second vehicle occupant when the second vehicle is in the target zone; and
a content provider coupled to the sensor and the display, the content provider being configured to respond to receipt of the signal from the sensor by transmitting information to the display and displaying the information on the display.

62. The system of claim 61 further including a transaction station for providing a drive-thru service to an occupant of the first vehicle, the sensor being spaced upstream of the transaction station relative to a direction of movement of the vehicles.

63. The system of claim 62 wherein the target zone is spaced upstream of the transaction station relative to the direction of forward movement a distance corresponding to the sum of a length of a portion of the first vehicle and an approximated common spacing between the first vehicle and the second vehicle.

64. The system of claim 62 wherein the transaction station includes the display.

65. The system of claim 61 wherein the sensor includes a light sensing element that detects light interference caused by the second vehicle.

66. The system of claim 61 wherein the sensor includes a weight sensing element that detects a weight of the second vehicle.

67. The system of claim 61 wherein the sensor includes a heat sensing element that detects heat emitted by the second vehicle.

68. The system of claim 61 wherein the sensor includes a vibration sensing element that detects vibration caused by the second vehicle.

69. The system of claim 61 wherein the sensor includes a magnetic field sensing element that detect a change in a magnetic field caused by the second vehicle.

70. The system of claim 61 wherein the sensor is further configured to generate a second signal in response to detecting the second vehicle exiting the target zone.

71. The system of claim 70 wherein the content provider is further configured to respond to receipt of the second signal from the sensor by discontinuing the displaying of information on the display.

72. The system of claim 61 wherein the display is positioned for viewing through a front, driver's side window of the second vehicle when the second vehicle is stopped in the target zone.

73. The system of claim 61 wherein the display is positioned for viewing through a front windshield of the second vehicle when the second vehicle is stopped in the target zone.

74. The system of claim 61 wherein the content provider includes a video playback device and a storage medium for storing data representing visual information, the video playback device retrieving the data and converting the retrieved data into the visual information on the display.

75. The system of claim 61 wherein the content provider includes a processor and a computer readable medium for storing digital data representing visual information, the processor accessing the digital data and converting the accessed data into the visual information on the display.

76. The system of claim 61 wherein the display is a speaker and the information is audio information.
